(19) United States
(12) Patent Application Publication
(10) Pub. No.: US 2013/0061514 A1
(43) Pub. Date: Mar. 14, 2013

(54) WEARABLE FISHING ROD HOLDER

(71) Applicant: Wayne Tracy Smith, Auckland (NZ)

(72) Inventor: Wayne Tracy Smith, Auckland (NZ)

(21) Appl. No.: 13/230,856

(22) Filed: Sep. 13, 2011

(51) Int. Cl. A01K 97/10

(52) U.S. Cl. 43/54.1

(57) ABSTRACT

The present invention relates generally to a wearable fishing rod holder for anglers, worn by a person while fishing, it secures a fishing rod to an angler. The rod holder is attached to an item of clothing or gear and is generally worn on an angler's chest. It releasably holds a fishing rod in a generally vertical position and is comprised of a rod support member and attachment member for securing the holder to the user. The rod support apparatus is mostly comprised of a deformable resilient and cushioned material that is formed so that it compresses upon the rod portion of a fishing rod to hold it securely.

### BACKGROUND OF THE INVENTION

1. Field of Invention

The present invention relates generally to a fishing rod holder for anglers, worn by a person while fishing, it secures a fishing rod to the angler.

Particularly to a wearable fishing rod holder, which is generally worn on an angler's chest and holds the fishing rod securely and in a fashion to be out of the way of the angler while their hands are free from supporting the rod. The holder allowing rods to be easily inserted and easily remove when needed.

The holster may also be used as a general article carrier where a portion of the item is an elongated rod such as a riding crop.

A fishing rod or a fishing pole is a tool used to catch fish, usually in conjunction with the pastime of angling, and can also be used in competition casting. A fishing rod is generally made of flexible pole.

While fishing it's often necessary for an angler to support their fishing rod in a way to free both hands. They can then use both hands to do such things as: tie a hook to the line, bating a hook, attaching a lure or artificial fly to the line, untangling the line and all other activities where it's beneficial to have both hands free.

Traditionally anglers hold the rod between their arm and body or place the bottom end of the rod on the ground or boat floor and lean it against them selves or some other object that is rarely ideal. Having to put down a rod to bait your hook or work on the terminal tackle while on a crowed boat usually results in putting the rod in the way of others. In the case of fly-fishing where the reel is located at the very end of the rod, the reel often gets dirty or damaged when placed on the ground. Most importantly an angler can't put a rod down when standing in a stream or lake.

The object of the present invention is to provide a simple and ergonomic fishing rod holder that overcomes the disadvantages referred to above.

2. Prior Art

Various forms of wearable fishing rod holders are know. Most are some form of elongated tube in which the butt end of a fishing rod is inserted, generally mounted on a large base assembly and don't work with fly fishing type rods. Others use multiple receiver sections, most are large, can easily get in the way while fishing, complex in construction, and not easily used.

All known prior art lacks at least one of the following claims of the present invention. The present invention has been adapted for securement of a fishing rod on a person where: 1) the fishing rod retention means is made of a single (one) rod receiver for receiving and holding the fishing rod; 2) the rod is retained from a single (one) section of the rod above the rod handle; 3) the holder and fishing rod are orientated generally vertically during operating conditions; 4) and where the portion of the receiver that secures the rod is constructed of a deformable resilient cushioned materials; 5) the rod holder includes a means that secures the holder to a person. The cited art does not include one or all of these claims.

See U.S. Pat. Nos. 1,198,202; 2,271,136; 2,273,136; 2,298,694; 2,356,209; 2,499,117; 2,537,456; 2,453,703; 2,572,889; 2,574,143; 2,589,126; 2,709,544; 2,846,129; 2,911,694; 2,947,456; 2,973,125; 3,186,611; 3,282,482; 3,749,294; 3,797,075; 3,847,315; 3,874,537; 3,917,134; 4,081,115; 4,431,122; 4,546,566; 4,739,914; 4,768,689; 4,802,612; 4,828,152; 4,896,806; 5,024,018; 5,246,154; 5,360,149; 5,416,956; 5,520,312; 5,571,228; 5,573,167; 5,662,251; 5,664,721; 5,772,091; 5,797,212; 5,915,942; 5,992,717; 6,003,746; 6,237,821; 6,267,276; 6,269,990; 6,616,024; 7,013,569; 2002/0152669; 2003/0051388; 2005/0145663; 2007/0234631. See foreign patents documents: FR2887403; GB2039701; GB2113982; GB2048633; GB2123675; GB2274049; GB2366989; JP10248464; JP2000157135; JP2001299174; JP2002306040; JP2008011776.

Though the following art may have similar attributes to the present invention, both have distinct design and material differences. Reference to relevant art follows:

(a) U.S. Pat. No. 7,594,354 represents a holder for a fishing rod, the general object of the invention being to provide a means for holding a fishing rod or binoculars from a shock cord, which includes an attached whistle, all of which hangs from around the neck of a person. In general this invention strives to solve one of the same problem as the present invention but differs in design and construction. The main difference being that it represents a S-shaped holder designed and constructed to hold the support member and fishing rod horizoninatly, U.S. Pat. No. 7,594,354 claim one states: “wherein another curved portion of said holder is attached to said loop of said shock cord such that said loop is inter fitted within said another curved portion and thereby maintains said cushioned material of said selected curved portion in an upwardly facing position during operating conditions”. The present invention comprises a means that orientates the holder and fishing rod vertically while being used. The cited art does not.

(b) New Zealand Pat. No. NZ236705 represents “a fishing rod and/or an attachment that can be fitted to the butt of a fishing rod in order to support the forearm of the angler.” It does comprise some of the same components of the present invention and though it can be in the form of an attachment and not just a rod feature, it lacks a means of attaching the invention and rod to the angler. It does have a flange that “is engageable with the forearm of the angler”, but this does not attach the invention to an angler any more than grasping the rod does, making the inventions significantly different. The present invention includes “a support means to secure the rod retention means to a person”; this invention does not.

3. Objects and Advantages

In keeping with the principle of the present invention the fishing rod holder is unique and technically different from other forms of holder.

The rod holder is uncomplicated in design, ergonomic, comfortable to wear and easy to use. It can be attached to and worn on any article of clothing or gear, or even worn on it's own hanging from a strap or cord from around an anglers neck or shoulder. The rod is held securely and in a fashion to be out of the way of the angler while their hands are free from supporting the rod. The holder allows rods to be easily inserted and easily remove when needed. It's construct of materials that can stand up to the rigors of fishing and is easily maintained.

Therefore the primary objective of the present invention is to provide a wearable fishing rod retention apparatus for use by anglers that holds a rod generally vertically and out of the way leaving both hands free.

The fishing rod retention apparatus in it simplest form is generally formed two primary members, a rod retention holder and a support member that attaches the rod holder to an angler.

The rod retention holder is generally formed of an elongated section of a deformable resilient and cushioned material statically affixed to a selected portion of a base made of rigid and durable material such that the holder maintains a fixed shape during operating conditions. The section of a deformable resilient and cushioned material having a longitudal gap or slit cut running vertically the whole length of the material from top to bottom. The gap/slit in the material allows the rod to be inserted into and removed from the material where the rod is held firmly but releasably by being inter-fitted within a selected area of the cushioned material. Having deformable resilient and cushioned material holding the fishing rod allows the holder to accommodate different types and sizes of rods.

The holder's general shape is in the form of an elongated tube. Alternatively it's general shape can be one of, or in any combination of the following shapes: a cube; an elongated: rectangle, square, circle, spade; or in the general shape of an elongated: “C”, “L”. “U” or “V”. It can be flat sided, rounded, have squared or angled corners if any.

The holder is further formed with a connection point located along the top rim of the holder. The holder is connected at this point to the support member. The support member is then connected to an anglers' person, clothing or gear using a flexible cord or any mechanical means that allows the holder to hang, pivot or swing independently of the angler. This orientates the holder and rod vertically during operating conditions.

Samples of possible support members are; flexible cord, lanyard, nylon webbing; or an mechanical means on it own or in conjunction with a cord or lanyard, such as a carbineer, safety pin, D-ring, split ring, fishing swivel, cable reel retractor, hook an loop materials or even a broach type bar pin.

Accordingly, there is a need to provide an improved wearable rod holder for anglers.

### Summary

It is therefore an object of the invention to provide a wearable fishing rod holder to enable an angler to comfortably and securely hold a fishing rod out of the way while allowing users hands to remain unencumbered.

It's also an object of the invention to provide a fishing rod holder where the fishing rod is both easily attached to and removed from the holder.

It's another object of the invention to provide a wearable fishing rod holder, which is capable of holding different types and sizes of fishing rods.

It's still another object of the invention to provide a wearable fishing rod holder that can be fastened on any type of clothing and gear.

It's also an object of the invention to provide a personal fishing rod holder which can stand up to the rigors or fishing while being easy to clean and maintain.

In accordance with the above and the other objects of the present invention, which will be discussed in detail below, a personal and wearable fishing rod holder is provided. The holder is made primary of deformable resilient cushioned materials that secure the rod and that's connected to a person using a connection member allowing the holder and rod to be carried vertically when in use.

Preferred embodiments of the invention are disclosed in the following descriptions.

In any of the following embodiments the primary members are interchangeable creating a new embodiment: Any base member may combine with any rod retention member and any rod holder may combine with any support member.

According to a first embodiment of the invention, the fishing rod holder in its simplest form includes a support member and a receiver member. The receiver member is formed of an elongated tube having two open ends and a longitudal side opening formed from rigid and durable material such as aluminum or plastic, and cushioned material such as foam rubber affixed to opposing sides of the inner surface of receiver. A gap or slit in the cushioned material runs the whole length of the receiver, parallel to and centered in the longitudal side rod access opening. Being deformable and depending on the size and shape of the slit/gap, the cushioned material allows the holder to support any size of fishing pole. The receiver is further formed with a single connection point for the support member. In its simplest form this is a hole in the receiver located along the top rim of the receiver. Locating the connection point at the top of the receiver forces the holder and fishing rod to hang vertically when in operational use. The support member also in its simplest form, comprises of a length flexible cord that passes thru the connection hole and is either tied to an angler's vest, clothing, and gear or even looped around the neck.

According to a second embodiment of the invention, the connection point that is located along the top rim of the receivers is also located within one of the two quarters of the radius nearest the longitudal side rod access opening. This positions the rod in the receiver where it cannot be accidently released from the receiver.

According to a third embodiment of the invention, the connection point is a raised tang with a hole located on the top edge of the receiver; this moves the connection point above and out of the way of the fishing rod. The second feature of this embodiment the receiver member may further comprise a secondary rod retention means in the form of a retaining strap that keeps the rod from being accidently released from the receiver. The strap is a length of webbing held across the rod insertion opening. One end of the webbing is held on one side of the opening using a rivet and the opposite end held releasably closed using hook and look materials. Any combination of fasteners could be used to hold the webbing releasably on one of or on both ends of the webbing and in any combination of: hook and loop materials, rivets, snaps, cleats and the like. And any form of material can be used to create the retention member: chain, rope, cord, leather, cotton or rubber strap, nylon or other forms of webbing.

According to a forth embodiment of the invention, the receiver member is again in the shape of an elongated round tube and the secondary rod retention means is comprised of a metal (or hard plastic) ring that fits around the exterior of the receiver. Made with its interior wall sized slightly smaller than the circumference of the exterior wall of the receiver, it rotates around the outside of the receiver while staying in place. The ring could alternately be place within a groove running along the circumference of the receiver to hold it in place. The ring is further comprised of an cutout approximately the same size as the rod access opening. Rotating the ring with to the point where both openings line up allows the rod to enter and exit the receiver, while rotating the ring so that it blocks the receiver opening keeps the rod from accidently being knocked from the receiver. The receiver and ring may be equipped with stops to keep it in a desired alignment. The ring may also be made of a spring steel clip, its ends may be flared outwards and back upon itself, and it may also be knurled. The second feature of this embodiment the support member is comprised of a split ring attached to the hole at the top of the receiver with a carabineer attached to the split ring. The rod holder is attached a D-ring on the fisherman's fishing vest using the carabineer.

According to a fifth embodiment of the invention, the receiver is in the general form of a elongated square tube open at both ends with a longitudal rod access cutout running from one open end to another in the longitudal center of one of its sides. The second feature of this embodiment the deformable and cushioned material, in this embodiment closed cell foam rubber, soft rubber, or felt can be used to form of two rectangles which are attached to the two opposing side walls of the receiver that run perpendicular to the rod opening. The two pieces form a gap where the rod is inserted and held releasably. The third feature of this embodiment the support member is comprised of a split ring attached to the hole at the top of the receiver with a safety pin attached to the split ring. The rod holder is attached directly to the fisherman's fishing vest, clothing, or gear using the safety pin. The safety pin may also be attached directly to the receiver without the use of a split ring or similar. Alternately a length of cord may be placed between the split ring and safety pin, making it easier to attach and remove the rod from the holder.

According to a sixth embodiment of the invention, the receiver is in the general form of a elongated square tube open at both ends with the longitudal rod access cutout running from one open end to another encompassing one of its corners. The second feature of this embodiment the deformable and cushioned material is in the form of a single block of material with a slip/gap where the rod is inserted and held releasably. The third feature of this embodiment the support member is connection to a hole in a tang formed at the top receiver and is comprised of a rivet, press stud, or even a small nut and bolt with/without washers, connecting the receiver to the anglers vest so that it can pivot around the connector to the vertical position while being used.

According to a seventh embodiment of the invention, the receiver is in the general form of a elongated rounded spade shaped tube open at both ends with longitudal rod access cutout running from one open end to another in the longitudal center at its widest point. The second feature of this embodiment the deformable and cushioned material, this time soft rubber, is in the form of a single piece of material with a slip/gap where the rod is inserted and held releasably. The third feature of this embodiment the support member is comprised of a broach style bar pin attached directly to the back and opposite the center of the longitudal rod access cutout. Thusly the receiver is pinned directly in the vertical and onto an angler's vest, clothing or gear.

According to a eight embodiment of the invention, the receiver is in the general form of a elongated round tube open at both ends with longitudal cutout running from one open end to another forming the rod access cutout. The second feature of this embodiment is that both opposing edges of the receiver base forming the rod insertion cutout are bent outward and back upon them selves creating tangs along both edges.

According to an ninth embodiment of the invention, the receiver is comprised mostly of a solid piece of deformable and cushioned material attached to a flat base member comprised of rigid and durable material that provides the attachment point for the support member. The deformable and cushioned material comprises a gap or slit in the cushioned material that runs the whole length of the receiver. Being deformable allows the holder to support any size of fishing pole. The receiver base member is further formed with a single connection point for the support member. In it's simplest form this is a hole located along the top edge of the receiver and opposite the longitudal side (rod insertion) opening. Locating the connection point at the top of the receiver makes the holder and fishing rod to hang vertically when in operational use. The support member comprises of a length flexible cord. This passes thru the connection hole and is either tied to an angler's vest, clothing, and gear or even looped around the neck.

According to an tenth embodiment of the invention, the support member comprises of a Retractable Cable Reel Tool carrier, like those common to fishing and outdoors gear attaching the rod receiver to the angler.

According to an eleventh embodiment of the invention, the receivers general shape can be one of, or in any combination of the following shapes: a cube; an elongated: rectangle, square, circle, spade; or in the general shape of an elongated: “C”, “L”. “U” or “V”. It can be flat sided, rounded, have squared or angled corners if any.

According to a twelfth embodiment of the invention, the support member may comprise generally of any form of cords, webbing, strap, chain, string, rings, cable reels, zingers or any mechanical or non mechanical fasteners, in keeping with attachment means used to connect the rod receiver to fishing vests, clothing or other gear.

Other objects and advantages of the present invention will become apparent to those skilled in the art upon reference to the following detailed description and appended claims, and upon reference to the accompanying drawings.

### DRAWINGS

### Figures

In the drawings, closely related figures have the same number but different alphabetic suffixes.

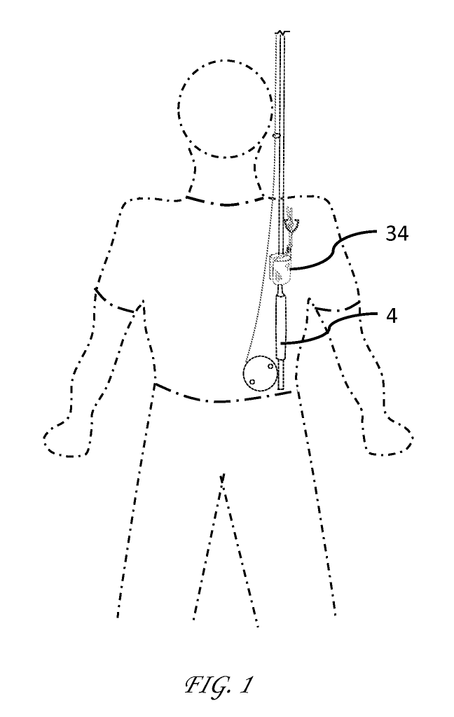

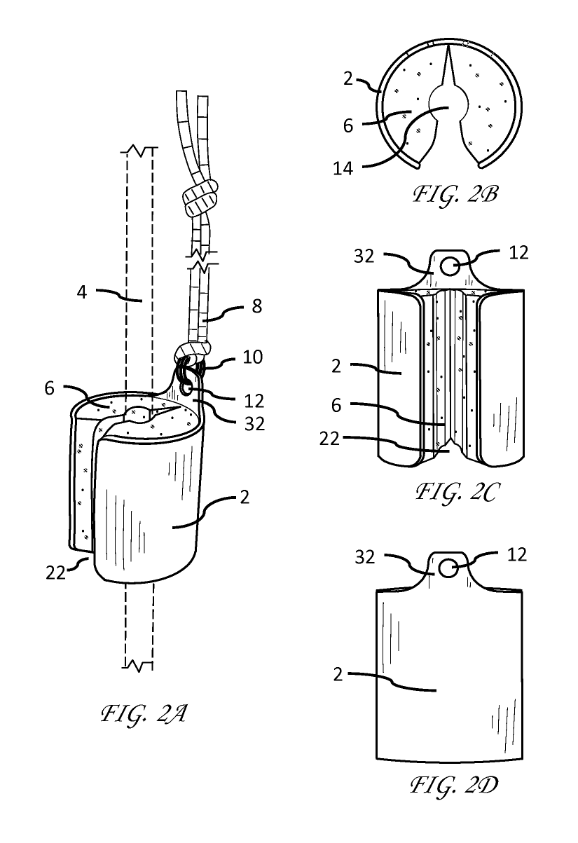

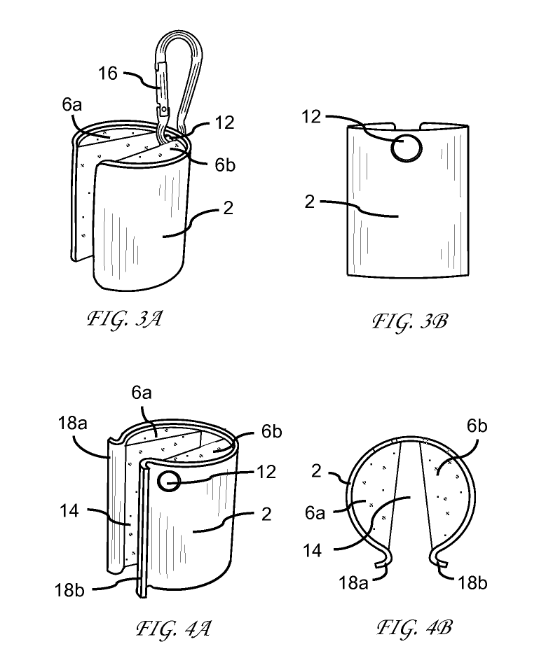

FIG. 1 is an elevational view, partly broken away, illustrating the fishing rod retention apparatus fitted to the front of an angler and supporting a fishing rod.

FIG. 2A is a perspective view of a preferred embodiment of the present invention.

FIG. 2B is a top plan view of the receiver further illustrating the general shape of the receiver and illustrating the positioning and shape of the deformable and cushioned material, which holds the fishing rod.

FIG. 2C is a front view of the receiver illustrating the rod access cutout and how the slit/gap in the cushioned material runs vertically the whole length of the receiver.

FIG. 2D is a rear view of the receiver illustrating the support member attachment point, which is comprised of a tang with hole.

FIG. 3A is a perspective view of another preferred embodiment of the present invention in it simplest form, illustrating simple foam inserts and how a carabineer can be used as the support member.

FIG. 3B is a rear view of the receiver illustrating the support member attachment point which is comprised of a hole located beneath the top edge of the receiver and opposite the rod access cutout.

FIG. 4A is a perspective view of another embodiment illustrating where the opposing edges of the receiver forming the rod access cutout are bent outward and back upon themselves creating tangs and also illustrating the support member attachment point which is comprised of a hole located beneath the top edge of the receiver and within the quarter of the radius nearest to the rod access cutout.

FIG. 4B is a top plan view of the receiver further illustrating the tangs forming the rod access area.

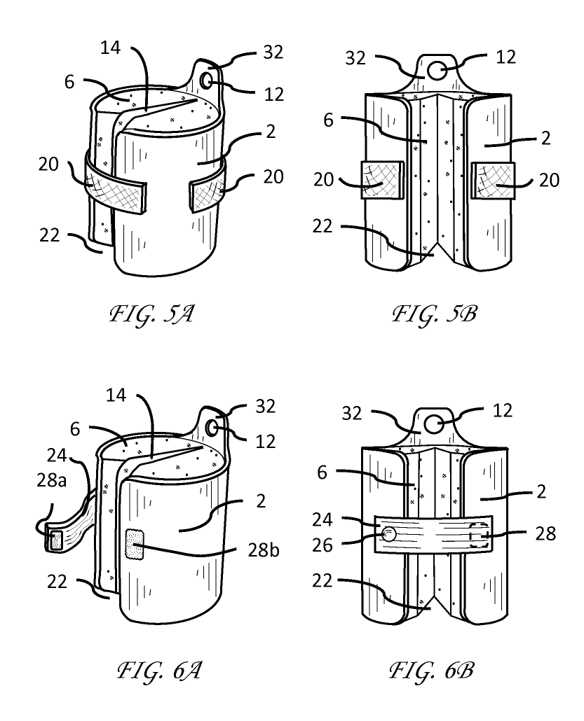

FIG. 5A is a perspective view of another embodiment where the receiver is fitted with a secondary rod retention means, which is comprised of a metal (or hard plastic) ring that fits around the exterior of the receiver. It's show in it's closed position blocking the rod access cutout.

FIG. 5B is a front view of the receiver, illustrating the rod retention ring in an open state.

FIG. 6A is a perspective view of another embodiment where the receiver is fitted with a different secondary rod retention means. In this case it's comprised of nylon webbing in the form of a strap, shown in its open state and how it's connected at one end to the receiver with hook and loop materials.

FIG. 6B is a front view of the receiver illustrating the rod retention strap closed across the rod access opening and attached to the receiver at one end by a rivet, and the other end by hook and loop materials.

FIG. 7 is a perspective view of another embodiment illustrating another receiver form variation and illustrating the support member, a retractable cable reel connected to the receiver.

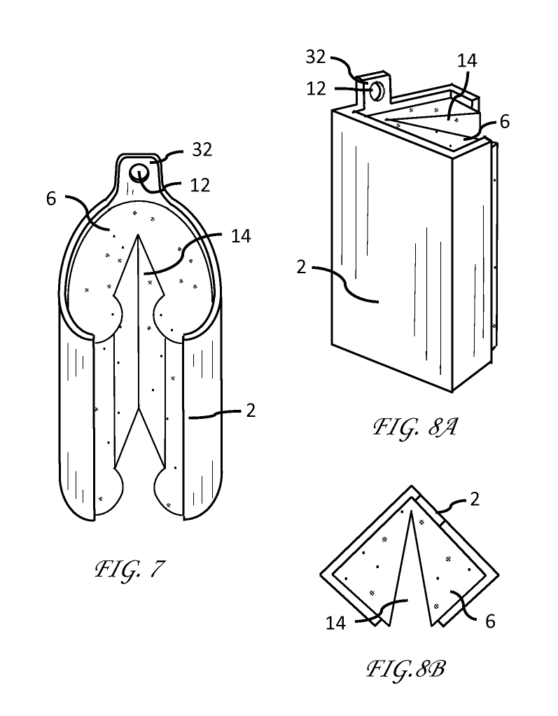

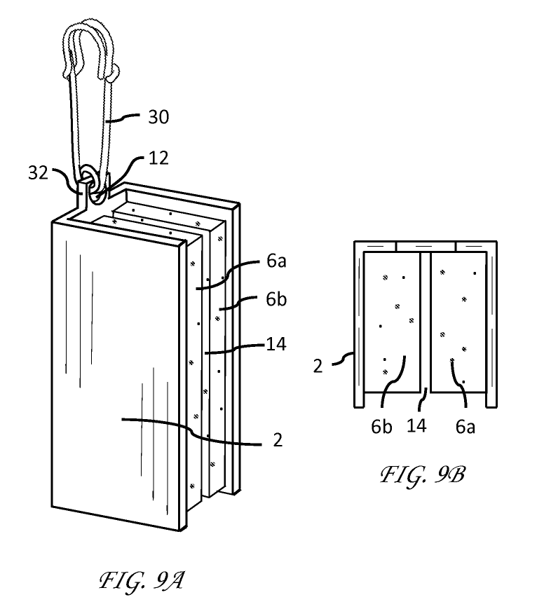

FIG. 8A is a perspective view of another embodiment illustrating another possible variation of the shape of the receiver with the rod access opening located at one corner of the receiver.

FIG. 8B is a top plan view of the receiver further illustrating the general shape of the receiver and illustrating the positioning and shape of the cushioned material.

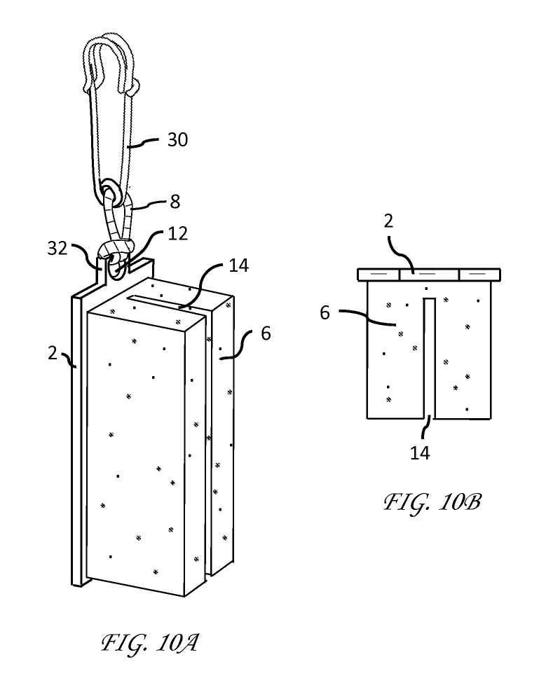

FIG. 9A is a perspective view of another embodiment this time the receiver in the shape of a elongated squared cornered “U” and illustrating two independent cushioned material inserts and how a safety pin can be used as the support member.

FIG. 9B is a top plan view of the receiver further illustrating the general shape of the receiver and illustrating how the two cushioned materials form a rod retention gap where the rod is held.

FIG. 10A is a perspective view of another embodiment where the receiver is comprised mainly of a single block of deformable and cushioned material coupled to a flat base section and illustrating a support member comprised of a length of flexible cord attached to a safety pin.

FIG. 10B is a top plan view of the receiver further illustrating the general shape of the receiver and illustrating the rod retention gap in the deformable and cushioned material.

DRAWINGS - Reference Numerals

| | | | |
|---|---|---|---|
| 2 | rod receiver base | 4 | fishing rod |
| 6 | deformable and cushioned material | 8 | flexible cord |
| 10 | split ring | 12 | attachment point hole |
| 14 | slit/gap | 16 | carbineer |
| 18 | rod opening tang | 20 | rod retention ring |
| 22 | rod access cutout | 24 | rod retention strap |
| 26 | rivet | 28 | hook and loop materials |
| 30 | safety pin | 32 | attachment tang |
| 34 | fishing rod retention apparatus | 36 | retractable cable reel |

### DETAILED DESCRIPTION OF THE PREFERRED EMBODIMENT(S)

In describing a preferred embodiment of the invention illustrated in the drawings, specific terminology will be resorted to for the sake of clarity. However, the invention is not intended to be limited to the specific terms so selected, and it is to be understood that each specific term includes all technical equivalents that operate in a similar manner to accomplish a similar purpose.

With reference to the drawings, in general, and to FIG. 1 in particular, multi-featured fishing rod retention apparatus #34 embodying the principles of the present invention is generally depicted. The #34 rod retention apparatus and #4 fishing rod are shown attached on an angler's front.

The fishing rod holder in the first preferred embodiment FIG. 2A the rod holder in this form includes a support member and rod retention member coupled together. The support member is an #8 flexible cord attached to a #10 split ring connected thru the #12 attachment point hole located in the #32 attachment tang on the #2 rod receiver base. The #2 rod receiver base is an elongated tube having two open ends and a #22 rod access cutout running the length of the #2 rod receiver base. Bonded to the inside of the #2 rod receiver base is the #6 deformable and cushioned material which includes the #14 slit/gap in the cushioned material that holds the #4 fishing rod.

FIG. 2B a top plan view of the preferred embodiment of FIG. 2A shows in more detail how the #6 deformable and cushioned material is shaped and how it forms the #14 slit/gap.

FIG. 2C a front elevation view of the preferred embodiment of FIG. 2A shows in more detail the #22 rod access cutout and its placement in relation to the #32 attachment tang.

FIG. 2D a rear elevation view of the preferred embodiment of FIG. 2A shows in more detail the #32 attachment tang and #12 attachment point hole.

Referring to FIG. 3A a perspective front view of the rod holder in one preferred embodiment, the support member is comprised of a #16 carbineer and illustrates it attached to the #2 rod receiver base thru the #12 attachment point hole.

FIG. 3B a rear elevation view of the preferred embodiment of FIG. 3A shows in more detail the #12 attachment point hole and illustrates its placement in relationship to the #2 rod receiver base.

FIG. 4A a perspective front view of the rod holder in one preferred embodiment, the #2 rod receiver base further comprises two #18A and #18B rod opening tangs and shows in more detail the #12 attachment point hole and illustrates an alternative placement point in relationship next to the #2 rod receiver base.

FIG. 4B a top plan view of the preferred embodiment of FIG. 4A shows in more detail the two #18A and #18B rod opening tangs.

Referring to FIG. 5A a perspective front view of the rod holder in one preferred embodiment, the #2 rod receiver base comprises a #20 rod retention ring fitted around the #2 rod receiver base in a closed position.

FIG. 5B a front elevation view of the preferred embodiment of FIG. 5A shows in more detail the #20 rod retention ring in the open position, allowing access thru the #22 rod access cutout.

FIG. 6A a perspective front view of the rod holder in one preferred embodiment, the #2 rod receiver base comprises a #24 rod retention strap in the open position, allowing rod access thru the #22 rod access cutout and illustrating the placement of the #28 hook and loop materials.

FIG. 6B a front elevation view of the preferred embodiment of 6A shows in more detail the #24 rod retention strap in the closed position blocking access to the #22 rod access cutout and further illustrates how it is attached on one end by the #26 rivet and on the other end by the #28 hook and loop materials.

Referring to FIG. 7 a perspective front view of the rod holder in one preferred embodiment, the support member is comprised of a #36 retractable cable reel tool attached to the #2 rod receiver base thru the #12 attachment point hole located in the #32 attachment tang, and illustrates an alternative shape of the #2 rod receiver base and #6 deformable and cushioned material.

FIG. 8A a perspective front view of the rod holder in one preferred embodiment, it illustrates an alternative shape of the #2 rod receiver base and #6 deformable and cushioned material and further illustrates the #32 attachment tang and #12 attachment point hole.

FIG. 8B a top plan view of the preferred embodiment of FIG. 8A shows in more detail the shape of the #2 rod receiver base and #6 deformable and cushioned material.

FIG. 9A a perspective front view of the rod holder in one preferred embodiment, it illustrates an alternative shape of the #2 rod receiver base how the rod retention means is comprised of two portions of #6a and #6b deformable and cushioned material, further illustrates the #32 attachment tang and #12 attachment point hole. The support means comprises of a #30 safety pin connected thru the #12 attachment point hole in the #32 attachment tang.

FIG. 9B a top plan view of the preferred embodiment of FIG. 9A shows in more detail the shape of the #2 rod receiver base and the two #6a and #6b deformable and cushioned material and illustrates how they form the #14 slit/gap.

FIG. 10A a perspective front view of the rod holder in one preferred embodiment, it illustrates an alternative shape of the #2 rod receiver base how the rod retention means is comprised of one portion of #6 deformable and cushioned material, further illustrates the #32 attachment tang and #12 attachment point hole. The support means comprises of a #30 safety pin attached to a #8 flexible cord and connected thru the #12 attachment point hole in the #32 attachment tang.

FIG. 10B a top plan view of the preferred embodiment of FIG. 10A shows in more detail the shape of the #2 rod receiver base and the #6 deformable and cushioned material and illustrates the #14 slit/gap.

One or more of the various advantageous features of the present invention may be incorporated into the fishing rod retention apparatus for beneficial results. These features provide benefit individually as well as collectively to produce a wearable fishing rod holder.

The foregoing description should be considered as illustrative only of the principles of the invention. Since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A fishing rod holder for securing a fishing rod(s) on a person comprising:
(a) a fishing rod retention means;
(b) said fishing rod retention means including a single (one) rod receiver for receiving and holding the fishing rod(s);
c) said rod receiver where the receiver is constructed of a deformable resilient cushioned material(s);
d) said rod receiver wherein the rod(s) is/are retained from a single (one) section of the rod above the rod handle;
e) said rod receiver includes means that orientates the receiver and rod(s) in a generally vertical position during operating conditions;
f) said fishing rod retention means including a support means to secure the rod retention means to a person.

2. Fishing rod holder as claimed in claim 1 wherein the rod receiver is comprised of a section of a deformable resilient and cushioned material(s) formed to compress on the rod(s) to secure it.

3. Fishing rod holder as claimed in claim 1 wherein the rod receiver is further comprised of rigid and durable material(s) statically affixed to a selected portion(s) of the deformable resilient and cushioned material(s).

4. Fishing rod holder as claimed in claim 3 wherein the portion of rigid and durable material is capable of maintaining the rod receiver in a fixed shape during operating conditions.

5. Fishing rod holder as claimed in claim 1 wherein the rod receiver is capable of receiving rods of different sizes and shapes.

6. Fishing rod holder as claimed in claim 1 wherein the rod receiver comprises an attachment means for the support means.

7. Fishing rod holder as claimed in claim 1 wherein the rod receiver further comprises a secondary rod retention means that keeps the rod(s) from being accidently released from the receiver.

8. Fishing rod holder as claimed in claim 7 wherein the secondary rod retention means is a retaining strap.

9. Fishing rod holder as claimed in claim 7 wherein the secondary rod retention means is a moveable ring with a cutout that fits around the exterior of the receiver.

10. Fishing rod holder as claimed in claim 7 wherein the moveable ring is further formed with it's interior wall sized slightly smaller than the circumference of the exterior wall of the receiver, this allows the ring to rotate around the outside of the receiver while staying attached to the receiver.

11. Fishing rod holder as claimed in claim 10 wherein the moveable ring is further placed within a groove running along the outside wall of the receiver.

12. Fishing rod holder as claimed in claim 10 wherein the moveable ring is held in place using studs and grooves in the receiver and ring.

13. Fishing rod holder as claimed in claim 1 wherein the support means includes a means of securing the rod retention means to a persons clothing, equipment or paraphernalia that is worn.

14. Fishing rod holder as claimed in claim 13 wherein the equipment or paraphernalia that is worn further includes angler's vests and packs.

15. Fishing rod holder as claimed in claim 1 wherein the support means comprises flexible and or mechanical supports, individually or in combination of: cords, webbings, rope, string, chain, retractable cable reels, rings, split rings, D-rings, kilt/safety pins, carbineers, bar pins, broach style bar pins, nuts and bolts, hook and loop materials, rivets, studs, press studs, extruded rubber and buttons; attached directly or indirectly to the receiver and or onto the person.

16. Fishing rod holder as claimed in claim 1 wherein the rod receiver comprises a means for attaching the receiver to the fishing rods furrels and/or guides.
